(19) United States
(12) Patent Application Publication
(10) Pub. No.: US 2026/0351139 A1
(43) Pub. Date: Nov. 5, 2026

(54) LABEL FOR A CONTAINER AND SYSTEM

(71) Applicant: Schreiner Group GmbH & Co. KG, Oberschleissheim (DE)

(72) Inventors: Philipp OLIVER, Starnberg (DE); Birgit RIEDMAIER, Gröbenzell (DE); Stefan KRAUSS, München (DE); Andreas HOFENAUER, Germering (DE)

(73) Assignee: Schreiner Group GmbH & Co. KG, Oberschleissheim (DE)

(21) Appl. No.: 19/482,297

(22) PCT Filed: May 3, 2024
(86) PCT No.: PCT/EP2024/062263

§ 371 Date: Nov. 7, 2025

(30) Foreign Application Priority Data
May 9, 2023 (DE) 10 2023 112 164.2

(51) Int. Cl. G09F 3/02; B65D 25/20; G09F 3/10

(52) U.S. Cl. CPC G09F 3/0288; B65D 25/205; G09F 3/10; G09F 2003/0251; G09F 2003/0269; G09F 2003/0272

(57) ABSTRACT

A label for a stepped container has a first container portion, a second container portion, and a container step arranged between the first container portion and the second container portion. The label includes a first adhesive region, which is configured to be fastened to the first container portion of the container, a second adhesive region, which is configured to be fastened to the second container portion of the container, wherein the first container portion and the second container portion have cross sections which differ from one another, and a transition region, wherein the transition region is arranged in a first direction between the first adhesive region and the second adhesive region and has a weakened structure, wherein the transition region is configured to be arranged on the container step.

The present disclosure relates to a label for a container. The disclosure further relates to a system comprising a container and a label described herein.

Labels are used, inter alia, for authorization, authentication or for proving the origin of a respective object provided therewith.

It is desirable to provide a label that allows simple and reliable use. It is also desirable to provide a system with a label that is easy and reliable to use.

According to one embodiment, a label for a stepped container has a first adhesion region. The label has a second adhesion region. The first adhesive region is configured to be fastened, in particular adhesively attached, to a first container section of the container. The second adhesive region is configured to be fastened, in particular adhesively attached, to a second container section of the container. The first container section and the second container section have different cross sections and/or different circumferences with respect to one another. In the case of a round or cylindrical container, the first container section and the second container section have different diameters, for example. In the case of a non-round container, in particular the circumferences of the two container sections are different from one another. The container has a container stage between the first and the second container section. The container stage is designed, for example, as an edge, as a hard transition, with roundings, as a soft transition, as a flowing transition and/or S-shaped.

The label has a transition region. The transition region is arranged along a first direction between the first adhesion region and the second adhesion region. The transition region has a weakening structure. The transition region is configured to be arranged on one of the container stages of the container. The weakening structure makes it possible for the first adhesive region and the second adhesive region to be fastenable, for example, in a stepped manner to the container.

By means of the transition region, in which a label base body of the label is weakened by means of the weakening structure compared to the first adhesion region and/or the second adhesion region, the arrangement of the first adhesion region and of the second adhesion region is possible on the stepped container as far as possible without wrinkles. The transition region provides a comparatively flexible, stretchable and/or compressible section. Thus, the second adhesion region can be applied to the second container section, even if the second container section has a smaller cross section or is configured smaller than the first adhesion region with respect to a direction transverse to the first direction. This size difference of the container is compensated for by means of the transition region, so that the label can be fastened to the label as completely as possible and without folds both with the first adhesive region and with the second adhesive region. In particular in the case of a rotationally symmetrical container, the label can thus be reliably fastened to the container despite different radii in the container sections.

The label makes possible a labeling of uneven containers that is as wrinkle-free as possible. In particular, the label is designed as an all-round or overwrap label. The weakening structure can be arranged in the region of a container stage and thus enables a flexible compensation of this container stage and as a result an attachment of the label on the container that is as wrinkle-free as possible.

Unevennesses and/or degrees of the label in the fastened state can thus be reduced or eliminated. This reduction of the folds compared to a conventional label enables an optically and aesthetically good appearance and a reliable fastening of the label. The label can be fastened to the container with as large a surface as possible. The label is configured to reliably cover a predetermined region of the container over the entire surface. For this purpose, in particular no heating, such as for example in the case of shrink labels, is necessary, which can damage, for example, a content of the container.

According to at least one embodiment, the transition region extends longitudinally extended along a second direction. The second direction runs transversely to the first direction, in particular the first direction and the second direction are oriented perpendicular to one another. Thus, the transition region with the weakening structure is configured to cover an annular container stage along the entire circumference.

According to at least one embodiment, the weakening structure has a punching. Alternatively, or additionally, the weakening structure has a recess. The punching is in particular a punching which does not completely cut through the label base body or a punched hole which extends completely through the label. The punching can also be designed as a perforation. The recess may have different shapes. In particular, a part of the label or of the label base body is removed by means of the recess. According to exemplary embodiments, the label has a plurality of punchings and/or recesses. The punchings and/or recesses allow a transition between the first adhesive region and the second adhesive region in the fastened state that is as wrinkle-free as possible.

According to at least one embodiment, the label has a flat label base body. The label base body has a first end side and an opposite second end side. The first end side and the second end side each extend along the first direction. The weakening structure extends from the first end side to the second end side. In particular, the weakening structure extends completely along the label between the first end side and the second end side. The label is thus designed, for example, as a wrap-around label, so that, in the fastened state, the first end side and the second end side adjoin one another in a flush manner and do not overlap.

According to a further embodiment, the label has an overlap region which is formed between the weakening structure and the second end side. The overlap region extends along the first direction. The overlap region is configured to be applied to an opposite coupling region. Thus, the label is designed in particular as an overwrap label. In particular, no weakening structure has to be formed in the overlap region. It is sufficient if the weakening structure is introduced into the label in such a way that the circumference of the container is completely or almost completely covered once. The overlap region is used, for example, to cover the adhesion regions and the transition region in the fastened state.

According to at least one embodiment, the coupling region is formed between the weakening structure and the first end side. This makes it possible, for example, to fasten the coupling region of the overlap region to one another over the entire surface, in particular without the weakening structure in the coupling region and/or in the overlap region.

According to at least one further embodiment, the coupling region is formed between the first end side and the overlap region. Thus, the overlap region is designed, for example, to cover a similarly large coupling region in which the weakening structure is also formed.

According to at least one embodiment, the label has a protruding region. The protruding region adjoins the weakening structure. The protruding portion is configured to cover the weakening structure. It is thus possible, in particular, to enable the stepped arrangement by means of the transition region and the weakening structure and to cover the weakening structure by means of the protruding region. The projecting region is therefore designed, for example, to cover the punchings and/or recesses of the weakening structure and to seal them, for example, in particular with respect to gases and/or radiation, such as UV radiation.

According to at least one embodiment, the label has a label layer which forms a barrier function. The barrier function is in particular against the passage of a gas. Alternatively or additionally, the barrier function is against the passage of a liquid Alternatively or additionally, the label layer forms a protective function against UV radiation or other electromagnetic radiation. Thus, by means of the label in the fastened state, a content of the container can be protected, in particular from UV radiation. The transition region with the weakening structure also enables this protective function reliably in the stepped arrangement of the label. Since the label can be arranged on the container as wrinkle-free or with minimized wrinkle formation as far as possible due to the transition region, the barrier function and/or the protective function can be reliably realized, since these are not disturbed by folding, for example. In conventional labels, with a stepped arrangement, these folds can occur, through which, for example, gases and/or UV radiation can penetrate and pass into the interior of the container. The label thus enables a reduction of the permeation, in particular for a container, which is not formed from glass, but, for example, from a plastic.

According to at least one embodiment, the label has an upper label which covers the first and/or the second adhesion region. The upper label is in particular formed as an additional label part which is coupled to the first and/or the second adhesion region. The upper label is designed, for example, with additional information and/or functionalities and has, for example, no weakening structure for the stepped arrangement of the first and the second adhesion region.

According to at least one embodiment, the upper label has a region protruding along the first direction over the second adhesion region. The upper label has a perforation along which the protruding region can be separated. For example, the protruding region can be connected to a closure member of the container. The upper label thus provides, for example, the functionality of an initial opening proof. The label is designed such that it can be coupled both to the container and to the closure member in the coupled state, so that, when the closure member is removed from the rest of the container body, the upper label tears along the perforation or is opened in another manner in order to enable removal of the closure member.

According to at least one further embodiment, the upper label has a viewing window and/or a removable region which provides access to the first adhesive region. Thus, the label is formed, even in the fastened state to enable for example an inspection of the contents of the container or to make a scale visible.

According to at least one further embodiment, the first end side has a stepped profile. The stepped profile is configured such that the first end side is arranged recessed at the second adhesion region. When the label is applied, this makes it possible for the first end side in the first adhesion region to be fastenable to the container before the second adhesion region. The forces occurring during, in particular, automated labeling are thus transmitted primarily by means of the first adhesion region. The forces are transmitted significantly reduced by means of the second adhesion region and/or the protruding region of the upper label. Thus, for example, toroidal force transmissions, which are undesirable in particular in the case of closure caps of sterile containers, can be avoided.

According to at least one embodiment, a system comprises a label as described herein according to at least one embodiment. The system comprises a container. The container has a first container section and a second container section along a first direction. The first container portion has a first cross section. The second container section has a second cross section. The first cross section and the second cross section are different from each other.

The container has a container stage which is arranged between the first container section and the second container section. The label is attached to the container. The first adhesive region is attached to the first container portion. The second adhesive region is attached to the second container portion. The transition region is arranged at the container stage.

Despite the container stage, the label is thus reliably attached to the container, since the transition region is configured to be flexible enough to compensate for the container stage. Thus, it is possible to fasten the second adhesive region to the smaller second container section and to fasten the first adhesive region to the larger container cross section without undesired folds or the like occurring here due to the stepped arrangement. Thus, in particular in the case of medical containers such as syringes, vials or injection vials or other pharmaceutical containers, reliable protection of the contents of the container can be realized by means of the label. In particular if the label is formed with a barrier function and/or protective function, a container content can thus be reliably protected from environmental influences.

For example, the container is a so-called luer syringe. The first container section is formed, for example, on the syringe body and the second container section is formed on the luer thread. The container stage is formed between the syringe body and the luer thread, which is formed, for example, in a range from a few micrometers to a few 10 μm transverse to the first direction, for example in a range between 30 and 50 μm, for example about 40 μm.

According to at least one embodiment, the first container section and the second container section and the container stage are formed on a common container body. The container body is, for example, formed in one piece or is composed of a plurality of container body parts.

It is also possible for the first container section to be formed on the container body and for the second container section to be formed on a closure member. In a coupled state, the container stage is formed between the container body and the closure member.

The label can be used in particular in systems in which it is necessary to cover the highest possible surface area of the container body in order to achieve a desired effect, for example in light protection applications, protection against UV radiation, protection against reactive gases, such as, for example, oxygen in relation to some medicaments. This protection and/or barrier effect can also be realized in the case of containers which have the container stage on account of the transition region.

Further advantages, features and developments result from the following exemplary embodiments explained in conjunction with the figures.

They show:

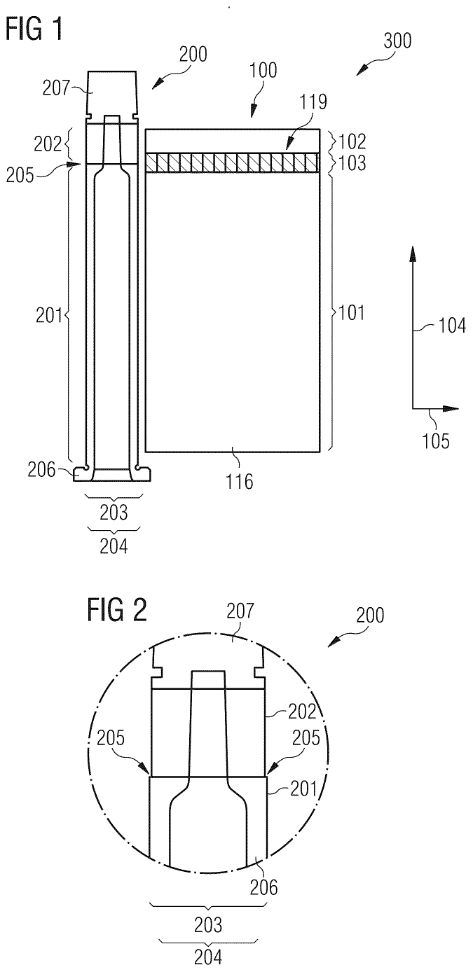

FIG. 1 shows a schematic illustration of a system according to an exemplary embodiment,

FIG. 2 shows a schematic illustration of a detailed view of a container according to an exemplary embodiment,

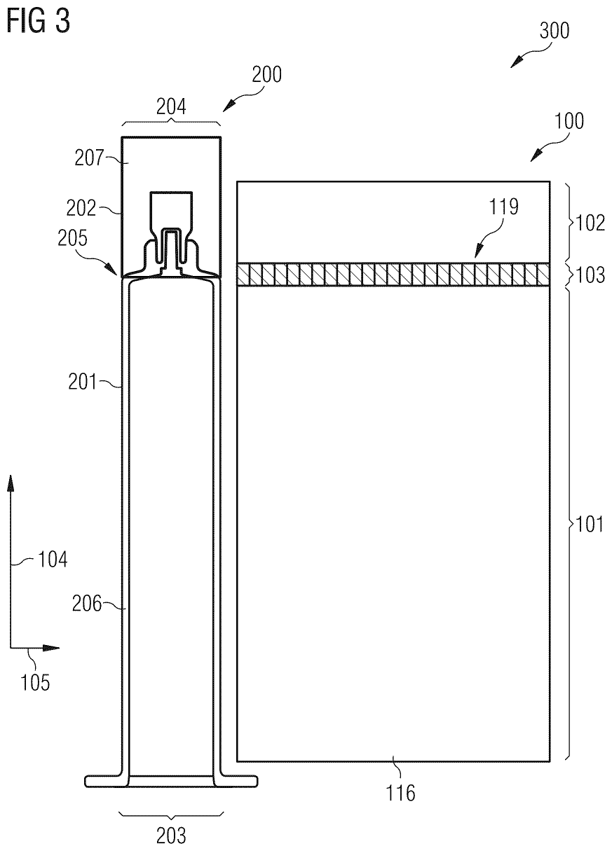

FIG. 3 shows a schematic representation of a system according to an exemplary embodiment,

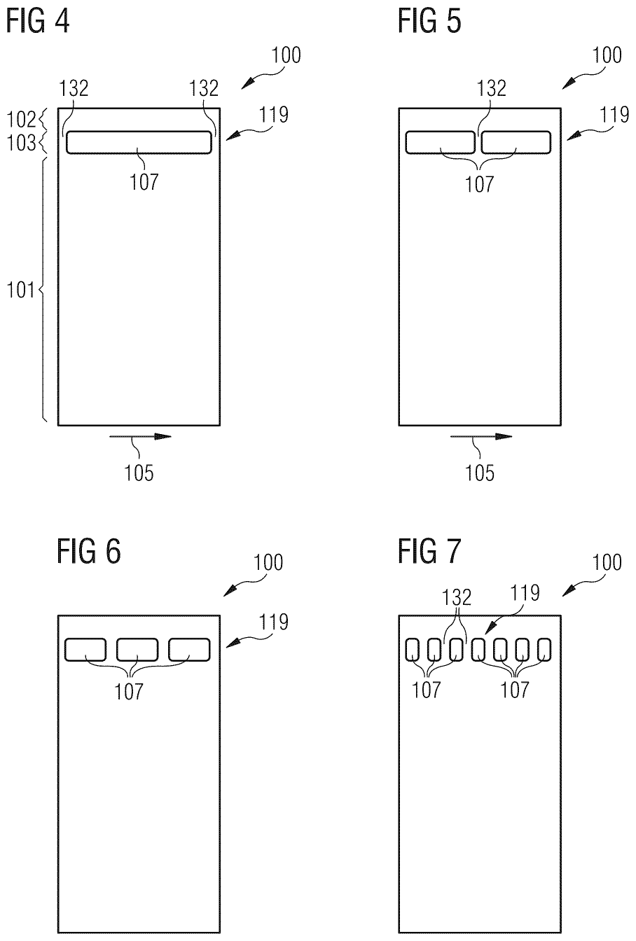

FIGS. 4 to 25 each show schematic representations of labels according to different exemplary embodiments, and

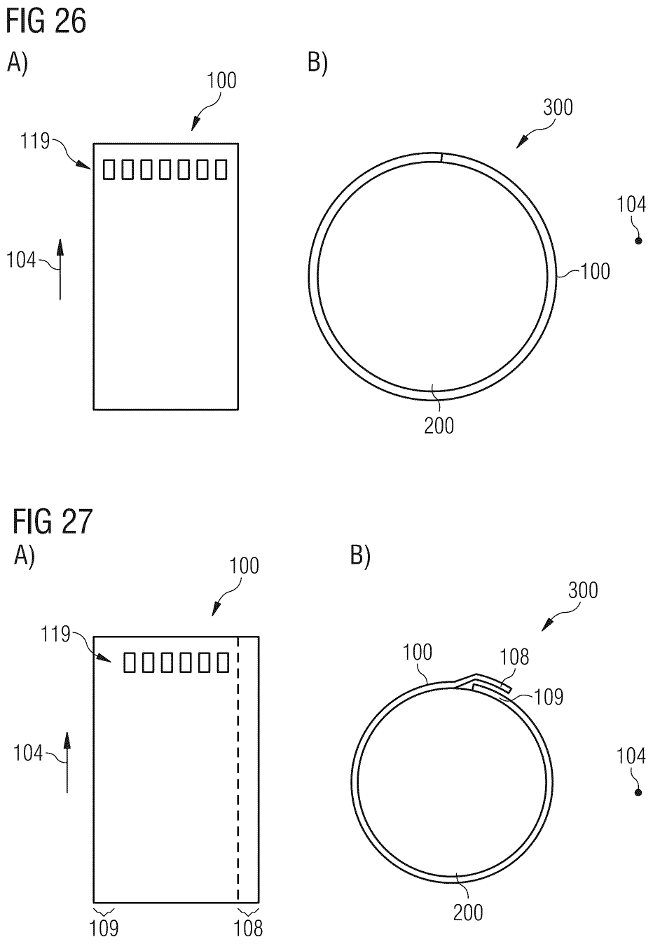

FIGS. 26 to 30 each show schematic representations of systems according to different exemplary embodiments.

FIG. 1 shows a system 300 according to an exemplary embodiment. The system comprises a container 200. In addition, the system 300 comprises a label 100, which is configured to be fastened to the container 200.

The container 200 is, for example, a syringe or another medical container. The container 200 has a container body 206. The container body 206 extends longitudinally extended along a first direction 104. The container body 206 has a first container section 201. The container body 206 has a second container section 202. Along the first direction 104, the second container section 202 adjoins the first container section 201.

As can also be seen in particular in the detailed illustration according to FIG. 2, a container stage 205 is formed between the first container section 201 and the second container section 202. The first container section 201 has a first cross section 203, in particular a first diameter 203. The second container section 202 has a second cross section 204, in particular a second diameter 204. The first cross section 203 is greater along a second direction 105 than the second cross section 204. The second direction 105 extends transversely to the longitudinal extension of the container body 206. The first direction 104 and the second direction 105 are in particular perpendicular to one another.

Due to the different cross sections 203, 204, the container stage 205 is formed.

For example, the second cross section 204 is smaller in a micrometer range than the first cross section 203. For example, the first cross section 203 is between 10 and 100 μm greater than the second cross section 204. In the cross section shown in FIG. 2, the container stage 205 has a projection of, for example, approximately 40 μm in each case on the left and on the right.

According to exemplary embodiments, the container 200 has a closure member 207. The closure member serves, for example, as a cover during transport and is removed, for example, before a medicament removal.

The container 200 is, for example, a so-called luer syringe. The second container section 202 has, for example, the luer thread.

Das Etikett 100 ist ausgebildet, auf dem Gefäß 200 appliziert zu werden. Insbesondere ist im dargestellten Ausführungsbeispiel das Etikett 100 ausgebildet, auf dem Gefäßkörper 206 mit dem ersten Gefäßabschnitt 201 und dem zweiten Gefäßabschnitt 202 befestigt zu werden, insbesondere mittels eines Klebers festgeklebt zu werden.

The label 100 is configured to be applied to the container 200. In particular, in the exemplary embodiment shown, the label 100 is configured to be fastened to the container body 206 with the first container section 201 and the second container section 202, in particular to be adhesively bonded by means of an adhesive.

The label 100 has a first adhesive region 101. This can also be referred to as the first label portion 101. The label 100 has a second adhesive region 102. This can also be referred to as second label portion 102. A transition region 103 is arranged between the first adhesion region 101 and the second adhesion region 102 along the first direction 104. The transition region 103 extends along the second direction 105 elongated along the label 100.

In dem Übergangsbereich 103 ist eine Schwächungsstruktur 119 ausgebildet, wie auch noch nachfolgend in Verbindung mit den weiteren Figuren näher erläutert wird. Die Schwächungsstruktur 119 ist ausgebildet, das Etikett 100 in dem Übergangsbereich 103 zu schwächen, so dass im Übergangsbereich 103 eine höhere Flexibilität beziehungsweise Dehnbarkeit ausgebildet ist als im ersten Haftbereich 101 und ohne am zweiten Haftbereich 102. Somit sind der erste Haftbereich 101 und der zweite Haftbereich 102 relativ zueinander zumindest geringfëgig beweglich dies ermöglicht eine verlässliche und möglichst faltenarme Applikation des Etiketts 100 an dem Gefäß 200 mit der Gefäßstufe 205.

A weakening structure 119 is formed in the transition region 103, as is also explained in more detail below in conjunction with the further figures. The weakening structure 119 is configured to weaken the label 100 in the transition region 103, so that a higher flexibility or stretchability is formed in the transition region 103 than in the first adhesion region 101 and without the second adhesion region 102. Thus, the first adhesion region 101 and the second adhesion region 102 are at least slightly movable relative to one another at least slightly, this allows a reliable and as low-fold application of the label 100 to the container 200 with the container stage 205.

The first adhesive region 101 is configured to be arranged on the first container section 201 with the first cross section 203, so that the first adhesive region 101 surrounds the first container section 201. Comparable thereto, the second adhesion region 102 is provided in order to be applied to the second container portion 202 with the second cross-section 204. The transition region 103 is arranged in the region of the container stage 205, so that the container stage 205 is surrounded by the transition region 103. The increased flexibility of the transition region makes it possible for the second adhesion region 102 to be arranged on the smaller second cross section 204 of the second container portion 202 without unwanted folds or the like being formed between the first adhesion region 101 and the second adhesion region 120.

For example, the label has a label layer 116 which provides a barrier function or a protective function for the container 200 and in particular for the contents of the container 200 For example, the label layer 116 is formed as a radiation protection layer and/or as a permeation protection layer. Thus, the label 100 serves to protect against UV radiation and/or light incidence. Alternatively, or additionally, the label 100 serves to protect against excessive permeation of reactive gases such as nitrogen oxides, ethylene oxide, H2O2 gas, oxygen, carbon dioxide, water vapor or solvent loss. Thus, it is possible, for example, to provide the container 200 from a material which alone does not provide a sufficient protective function, for example the container 200 is made of a transparent plastic. The label 100 is applied to the container 200 to protect the sensitive content in the container 200, such as a medical device. This protection can be achieved in a particularly reliable manner on account of the reliability that is as smooth as possible and over the full surface area of the label 100.

FIG. 3 shows the system 100 according to a further exemplary embodiment. In the case of the container 200 according to the exemplary embodiment of FIG. 3, the second container section 202 is formed on the closure member 207. The container stage 205 is thus along the first direction 104 between the container body 206 and the closure member 207.

The label 100 is designed such that the second adhesive region 102 can be applied to the closure member 207. The closure member 207 has the smaller second cross section 204 compared to the container body 206, which has the larger first cross section 203. The label 100 with the transition region 103 nevertheless enables a reliable dispensing of the first adhesion region 101 and of the second adhesion region 102, wherein the container stage 205 is compensated for by means of the transition region 103.

Of course, other arrangements of the container stage 205 on the container 200 shown in FIGS. 1 to 3 are possible. The label 100 is matched in particular in its dimensioning and the arrangement of the transition region 103 to the respective container 200, so that the transition region 103 is always provided at the level of the container stage 205. It is also possible for the container 200 to have more than one container stage 205, that is to say for example a plurality of container stages 205 such as, for example, 2, 3 or more container stages 205. Accordingly, the label 100 has a plurality of transition regions 103. In particular, the number of transition regions 103 of the label 100 corresponds to the number of container stages 205 of the container 200.

Various embodiments of the transition region 103 and the weakening structure 119 are described in connection with FIGS. 4 to 17. Other exemplary embodiments shown in FIGS. 4 to 17 are also possible in order to form the weakening structure 119.

In the exemplary embodiment according to FIG. 4, the weakening structure 119 is formed by means of a single recess 107. The recess 107 extends along the second direction 105 in an elongate manner along the label 100. Along the second direction 105, a rib is formed on both sides of the recess 107, so that the first adhesive region 101 and the second adhesive region 102 are formed contiguously.

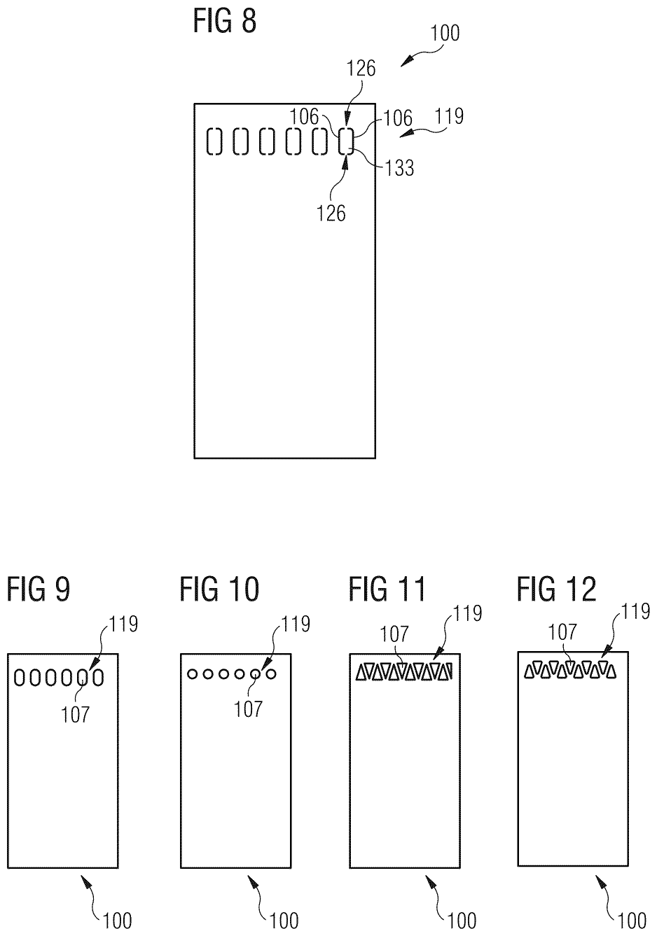

As shown in FIGS. 5 to 7, the weakening structure 119 according to further exemplary embodiments is formed by means of a plurality of recesses 107 arranged next to one another along the second direction 105. For example, two, three or more recesses 107 are provided to form the weakening structure 119. Due to connecting ribs 132, which are each arranged between the recesses 107 along the second direction 105, the first adhesive region 101 and the second adhesive region 102 are connected to one another. In the exemplary embodiment according to FIG. 8, a punching 106 is provided in order to form the weakening structure 119. The punching has, for example, a shape similar to the recesses 107 according to FIGS. 4 to 7. However, retaining webs 126 remain, so that the label regions 133 surrounded by the punching 106 are not completely removed, but are furthermore coupled to the first adhesive region 101 and the second adhesive region 102. As a result, for example, an improved protection and/or barrier functionality is also possible in the region of the weakening structure 119.

According to exemplary embodiments, the punching 106 is a punching which does not completely penetrate the label 100 along the punching direction. According to further exemplary embodiments, the punching 106 is punched completely through the label, so that the label is completely severed in the region of the punching 106. It is also possible to form the punched hole 106 as a perforation. A combination of the various punching possibilities is also possible.

FIGS. 9 to 12 show different shapes for the recess 107. Of course, other further shapes (not explicitly shown) for the recesses 107 may also be possible. It is also possible to combine different shapes with each other. According to FIG. 9, oval recesses 107 are provided. FIG. 10 shows round recesses 107. FIG. 11 shows triangular recesses 107. In each case immediately adjacent triangles are arranged rotated by 180° with respect to one another. FIG. 12 shows a triangular shape for the recesses 107 in which the tips are rounded.

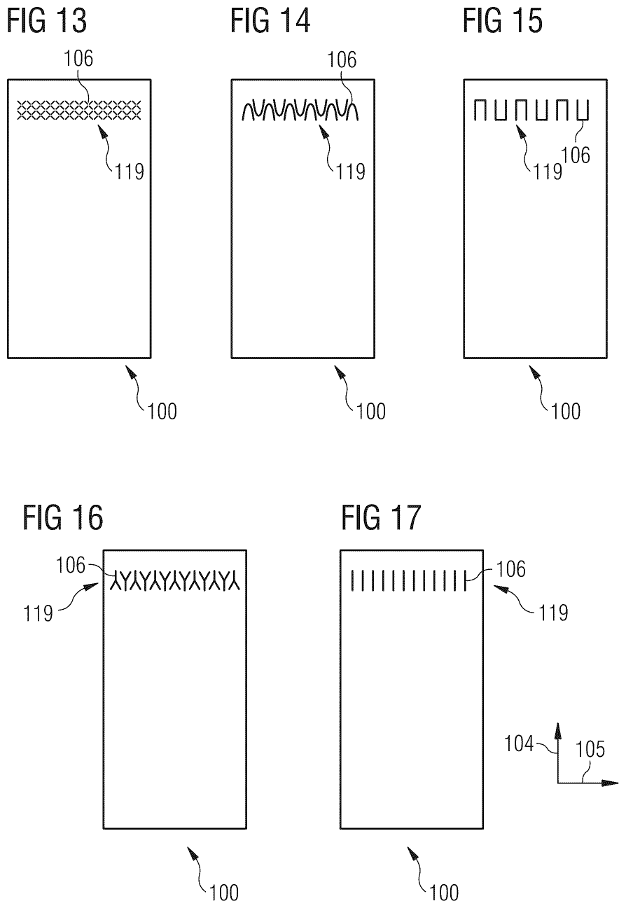

FIGS. 13 to 17 show different configurations for the punching 106. Of course, other forms not explicitly shown can also be used for punching 106. It is provided for and combinations of the different forms of the punching 106 are also possible.

FIG. 13 shows a network structure for the punching 106.

FIG. 14 shows a V-shape, wherein the tip is rounded. An angular tip is also possible.

FIG. 15 shows a U-shape for the punching 106. Angular or rounded tips are also possible here.

FIG. 16 shows a Y-shape in which the punching 106 has a plurality of Y-shaped punchings.

FIG. 17 shows an I-shaped punching, in which a plurality of straight cuts extending along the first direction 104 are arranged next to one another along the second direction 105.

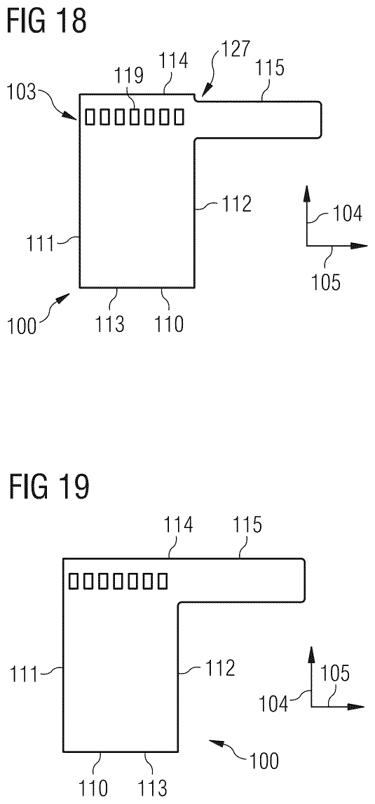

FIG. 18 shows the label 100 according to a further exemplary embodiment The label 100 has a protruding region 115. The protruding region projects along the second direction 105. In particular, the protruding region 115 adjoins the transition region 103. It is thus possible to cover the weakening structure 119 by means of the projecting region 115 in the applied state. The label 100 wraps around the container 200 and the protruding area is wound in a further label layer over the weakening structure 119. The weakening structure 119 is thus covered by means of the projecting region 115. The protruding region 115 also enables an additional protection and barrier function in the transition region. The punchings 106 and/or the recesses 107, through which, for example, light and/or gas can pass, are covered by means of the projecting region 115, so that protection against environmental influences is also ensured in the transition region.

The label 100 has a label base body 110, which is rectangular, for example. The label base body 100 has a first end side 111 extending along the first direction 104. A second end side 112 of the first end side 111 is arranged opposite the first direction 104. A third end side 113 and a fourth end side 114 each extend along the second direction 105 and connect the first end side 111 and the second end side 112.

In the illustrated exemplary embodiment, the projecting region 115 projects from the second end side 112. The label 100 is attached to the container 100 starting with the first end side 111 and wound up.

The projecting region is arranged on the second end side 112, so that the step 127 is formed on the fourth end side 114. The fourth end side 114 thus has a stepped region along the second direction 105, wherein the fourth end side 114 runs back in the protruding region 115 along the first direction 104, so that the step 127 is formed.

As shown in FIG. 19, the step 127 according to further exemplary embodiments can also be dispensed with. The label 100 according to FIG. 19 corresponds to the label according to FIG. 18, wherein the fourth end side 114 does not have a stepped profile but runs in a straight line.

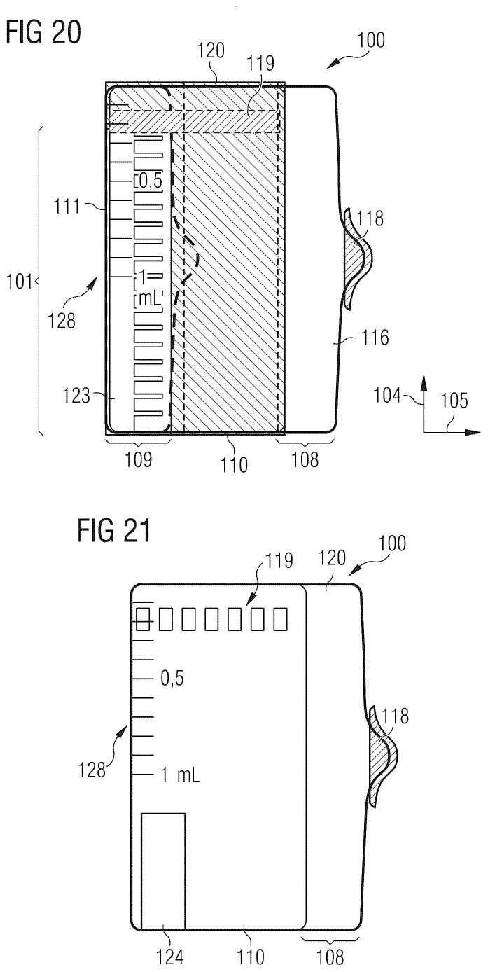

FIG. 20 shows the label 0 according to a further exemplary embodiment. In addition to the label base body 110, the label 100 according to FIG. 20 has an upper label 120. The upper label 120 enables the integration of additional functionalities into the label 100. For example, the upper label 120 is made of a different material than the label base body 110. For example, the upper label 120 can be unwound at least partially from the label base body 110. For this purpose, for example, the grip tab 118 is provided on the upper label 120.

The upper label 120 is formed, for example, from a non-transparent material and, for example, opaque.

The upper label 120 covers, for example, the weakening structure 119, in a state in which the label 100 is fastened to the container 200 as intended. According to exemplary embodiments, the upper label 120 has various functional elements such as, for example, a viewing window 123 and/or a scale 128. In particular if the upper label is opaque and has, for example, a light protection functionality, the viewing window is provided in order to enable an inspection of the contents of the container 200. Alternatively, or additionally, the amount of the content in the container 200 can be easily determined by means of the scale 128.

The label 100 according to FIG. 20 is designed as an overwrap label. A coupling region 109 is provided on the first end side 111 along the second direction 105. The coupling region 109 extends over a predetermined width along the second direction 105 and extends over the label 100 along the first direction 104. An overlap region 108 is formed opposite the second direction 105. In particular, the overlap region directly adjoins the grip tab 118. In the operational state, the overlap region 108 is arranged on the coupling region 109. The label 100 thus has a greater extent along the second direction 105 than the circumference of the container 200. For example, the label base body 110 has an extension so that the container 200 is completely surrounded once by the label base body 110 with the transition region 103 and the weakening structure 119. Thus, the most wrinkle-free application of the label 100 to the container 200 is possible. The upper label 120 has, for example, a greater extent than the label base body 110, so that the upper label 120 forms the overlap region 108, which protrudes beyond the label base body 110 in the non-applied state and covers the coupling region 109 in the applied state. For example, the overlap region 108 along the second direction 105 is longer than the coupling region 109.

FIG. 21 shows the label 100 with the upper label 120 according to a further exemplary embodiment. The top label 120 has a removable region 124. The removable region enables, for example, documentation and/or inspection of the content of the container 200. In the exemplary embodiment shown, the scale 128 is also shown. The various functionalities such as the viewing window 123, the removable region 124 and the scale 128 can each be provided in any combination with one another or else only individually.

The label base body 110 and the top label 120 are, for example, fixedly connected to one another, so that they are not separated from one another when used as intended.

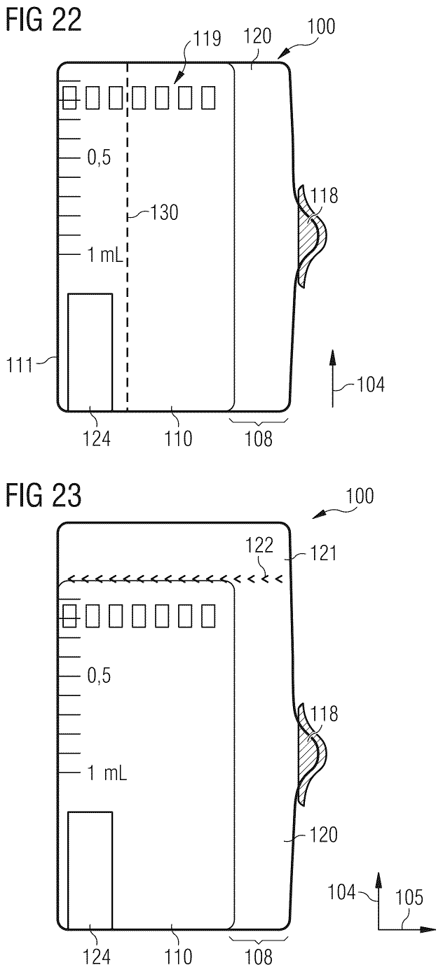

FIG. 22 shows an embodiment in which the top label 120 has a perforation 130. The top label 120 is detachable from the rest of the label along the perforation 130 extending along the first direction 104. In particular, a part of the upper label 120 can thus be detached from the label base body 110, which thus remains on the container 200 in the fastened state.

FIG. 23 shows the label 100 in an exemplary embodiment in which a first-opening detection functionality is realized. The top label 120 has a protruding region 121. The projecting region 121 extends along the second direction 105 over the label 100 and is arranged along the first direction 104 above the label base body 110. The protruding region 121 can be coupled, in particular, to the closure member 207. The remaining label 100 can be coupled to the container body 206. During the first removal of the closure member 207, the protruding region 121 tears off from the rest of the label 100 along a perforation 122. The perforation 122 extends along the second direction 105. FIG. 23 shows the upper label 120 with the overlap region 108 and the removable region 124. It is also possible to configure the label 100 with the protruding region 121 without the overlap region 108 and/or without the removable region 124.

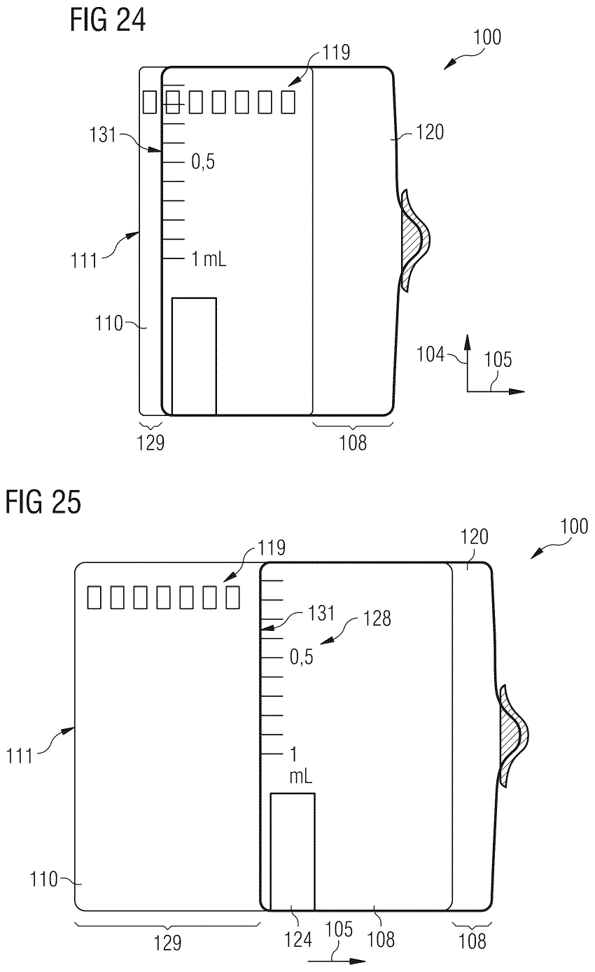

According to exemplary embodiments, the label base body 110 and the upper label 120 are arranged flush on the first end side 111. It is also possible for the label base body 110 and the top label 120 to be arranged offset with respect to one another along the second direction 105, as illustrated, for example, in FIGS. 24 and 25. The top label 120 has an edge 131 extending along the first direction 104 and facing the first end side 111. The first end side 111 and the edge 131 are arranged offset with respect to one another along the second direction 105. For example, an offset 129 between the first end side 111 and the edge 131 is smaller than the circumference of the container 200. The label base body 110 is formed to completely surround the container 200 once and the top label with the overlap region 108 is particularly formed to cover the label base body 110 exposed in the offset 129 in the operational state.

It is also possible that the offset 129 is as large as the circumference of the container 200 or larger, as shown, for example, in FIG. 25. The label base body 110 has, along the second direction 105, the overlap region 108 in which no weakening structure 119 is provided. For example, the label base body 110 extends along the second direction 105 over a length corresponding to twice the circumference of the container. Thus, the label base body 110 can be applied directly to the container in the region, into the weakening structure 119, in order to bridge the container stage 209. This is followed by a double wrapping with the overlap region 108 of the label base body 110.

In the exemplary embodiment shown, the offset 129 between the first end side 111 and the edge 131 is approximately as large as the circumference of the container. Thus, the upper label 120 unwinds the container in particular twice, but once and additionally also a small piece with the overlap region 108 of the upper label 120.

FIG. 26 shows the system 300. FIG. 26A shows the label 100 and FIG. 26B shows a sectional view transverse to the first direction 104 of the container 200 with the attached label 100. The label 100 has the weakening structure 119 and is simply wound around the container 200 without overlapping the label 100 and without closure or overlapping of the weakening structure 119.

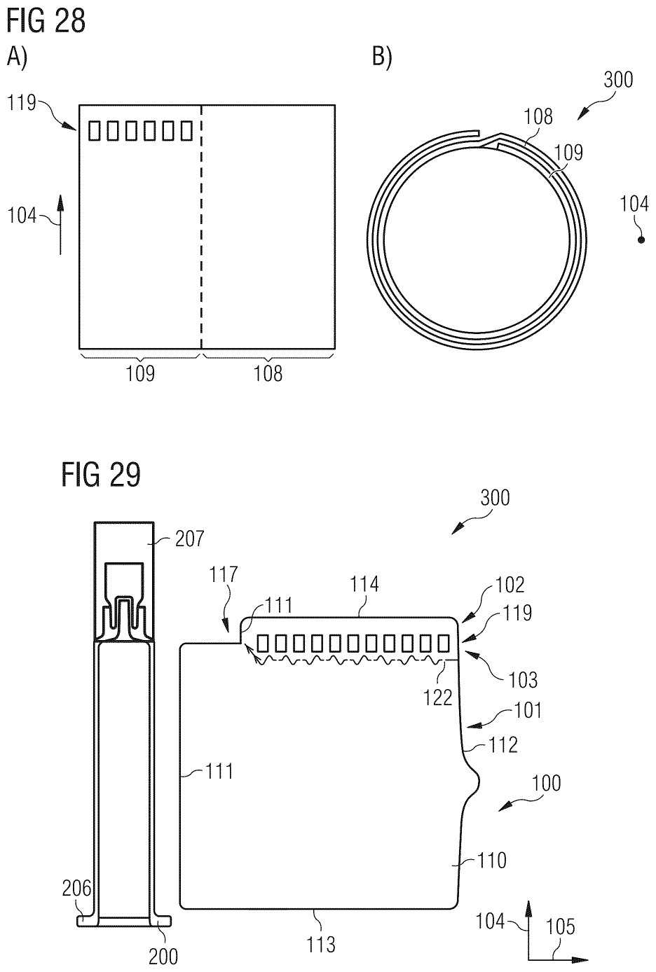

The exemplary embodiment according to FIG. 27 shows the label 100 with the overlap region 108 and the coupling region 109. The label 100 is comparable to FIG. 26 in a simple manner around the container 200, but in addition the overlap region 108 and the coupling region 109. The weakening structure 119 is not additionally covered or overlapped. In the exemplary embodiment according to FIG. 28, the label is wound twice, so that the weakening structure 119 is covered by the overlap region 108. Thus, the recesses 107 and/or the punchings 106 of the weakening structure 119 are additionally closed around to increase the protective function of the label 100. This functionality can also be realized in a comparable manner with a label 100 according to FIGS. 18 and 19 with the projecting region 115.

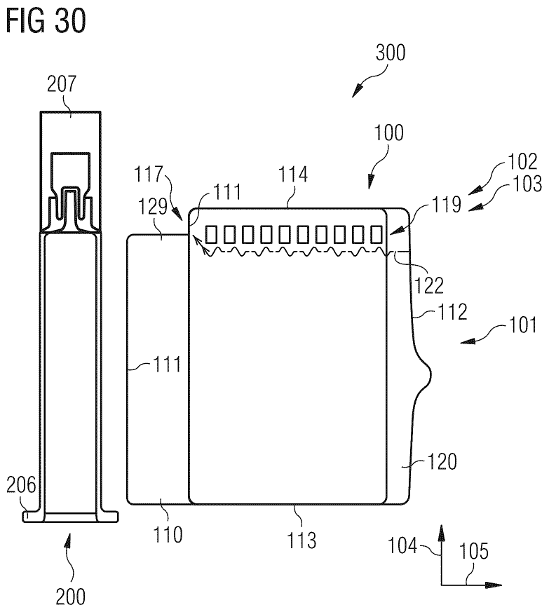

FIGS. 29 and 30 show further exemplary embodiments of the system 300, in which the first end side 111 has a stepped profile 117. The first end side 111 has a recessed region in the region of the transition region 103 of the second adhesion region 102, so that the stepped profile 117 is produced. Thus, in the region of the first adhesion region 101, the first end side 111 is arranged so as to project along the second direction 105. When applying the label 100, it is thus possible to fasten the label to the container body 206 starting with the first end side 111 in the first adhesion region 101. The label 100 is wound around the container 200 and only at a later point in time the second adhesive area 102 is also fastened, for example, to the closure member 207. Thus, the comparatively large torsional forces at the beginning of the dispensing of the label 100 are taken up in advance by the container body 206. The closure member 207 must therefore absorb less forces. Unintentional loosening of the closure member 207 during the dispensing of the label 100 can thus be avoided.

A label structure with a stepped profile 117 without the weakening structure 119 and an associated method for application are described in German patent application 10 2023 102 140, the content of which is hereby incorporated by reference completely.

FIG. 29 shows the label 100 with the label base body 110 and the stepped profile 117 of the first end side 111 in a single-layer variant.

FIG. 30 shows the label 100 with the stepped profile 117 of the first end side 111 in a multi-layer variant with the label base body 110 and the upper label 120.

The various functionalities and embodiments of the label, in particular according to FIGS. 4 to 30, can be combined with one another in a wide variety of combinations. Individual features of the embodiments shown in the figures may be combined with other embodiments to the extent that this is technically feasible, for example the viewing window 123, the detachable region 124 and/or the scale 128 with the labels 100 according to FIGS. 29 and 30. It is also possible, for example, to provide the projecting region 121 as first opening proof in the case of the labels according to FIGS. 29 and 30. In particular, the perforation 122 is provided between the first adhesive region 101 and the transition region 103, as shown in FIGS. 29 and 30.

The label 100 enables a reliable application to the container 200 despite the container stage 205. The label 100 enables a reliable barrier functionality, in particular for a container 200 made of a plastic. Alternatively, or additionally, the label 100 enables a reliable UV light protection functionality, in particular for the container 200 made of a plastic. The label 100 and the system 300 are particularly suitable for applications in the pharmaceutical field.

### REFERENCE SIGNS

100 label
101 first adhesion area
102 second adhesion area
103 transition region
104 first direction
105 second direction
106 punching
107 recess
108 overlap region
109 coupling region
110 label base body
111 first end side
112 second end side
113 third end side
114 fourth end side
115 projecting portion
116 label layer
117 graded pattern
118 grip tab
119 attenuation structure
120 top label
121 protruding region
122 perforation
123 viewing window
124 removable region
126 retaining web
127 stage
128 scale
129 offset
130 perforation
131 edge
132 connecting rib
133 label area
200 container
201 first container section
202 second container portion
203 first cross section
204 second cross-section
205 container stage
206 container body
207 closure member
300 system

1. A label for a stepped container (200) having a first container section (201), a second container section (202), and a container stage (205) disposed between the first container section (201) and the second container section (202), the label comprising:
a first adhesion area (101) adapted to be attached to the first container portion (201) of the container (200);
a second adhesion region (102) configured to be attached to the second container portion (202) of the container (200), wherein the first container portion (202) and the second container portion (202) have different cross-sections (203, 204) relative to each other; and
a transition region (103), wherein the transition region (103) is arranged along a first direction (104) between the first adhesion region (101) and the second adhesion region (102) and has a weakening structure (119), wherein the transition region is configured to be arranged at the container stage.

2. The label according to claim 1, wherein the transition region (103) extends longitudinally extended along a second direction (105), the second direction (105) extending transverse to the first direction (104).

3. The label according to claim 1, in which the weakening structure (119) has a punching (106) and/or a recess (107).

4. The label according to claim 1, in which the label (100) has a flat label base body (110) which has a first end side (111) and an opposite second end side (112) which each run along the first direction (104), wherein the weakening structure (119) extends from the first end side (111) to the second end side (112).

5. The label according to claim 1, wherein the label (100) has a flat label base body (110), which has a first end side (111) and an opposite second end side (112), which each run along the first direction (104), wherein an overlap region (108) is formed between the weakening structure (119) and the second end side (112), which overlap region extends along the first direction (104) and is configured to be applied to an opposite coupling region (109).

6. The label according to claim 5, wherein the coupling region (109) is formed between the weakening structure (119) and the first end side (111).

7. The label according to claim 5, wherein the coupling region (109) is formed between the first end side (111) and the overlap region (108).

8. The label according to claim 1, further comprising a projecting region (115) which adjoins the weakening structure (119), and which is configured to cover the weakening structure (119).

9. The label according to claim 1, further comprising a label layer (116) which forms a barrier function against a passage of a gas and/or a liquid and/or a protective function against UV radiation.

10. The label according to claim 1, further comprising an upper label (120) covering the first and/or second adhesive regions (101, 102).

11. The label according to claim 10, wherein the top label (120) comprises a protruding region (121) protruding along the first direction (104) over the second adhesive region (102), and a perforation (122) along which the protruding region (121) is separable.

12. The label according to claim 10, in which the upper label (120) comprises a viewing window (123) and/or a removable region (124) for access to the first adhesive region (101).

13. The label according to claim 1, wherein the first end side (111) has a stepped course (117) such that the first end side (111) is arranged recessed at the second adhesion region (102).

14. A system comprising:
a container (200) which has a first cross section (203) along a first direction (104) in a first container section (201) and has a second cross section (204) in a second container section (202), and a container stage (205) which is arranged between the first container section (201) and the second container section (202), wherein the first cross section (201) and the second cross section (202) are different from one another,
the label (100) according to claim 1 attached to the container (200), wherein the first adhesive area (101) is attached to the first container section (201), the second adhesive area (102) is attached to the second container section (202), and the transition area (103) is arranged at the container stage (205).

15. The system according to claim 14, wherein the first container portion (201), the second container portion (202) and the container step (205) are formed on a common container body (206).

16. The system according to claim 14, wherein the first container portion (201) is formed on a container body (206) and the second container section (202) is formed on a closure member (207) and the container step (205) is formed in a coupled state between the container body (206) and the closure member (207).
